(19) United States
(12) Patent Application Publication
(10) Pub. No.: US 2016/0301812 A1
(43) Pub. Date: Oct. 13, 2016

(54) DETERMINING AN ACTION IN RESPONSE TO AN EVENT

(71) Applicant: HEWLETT-PACKARD DEVELOPMENT COMPANY, L.P., Houston, TX (US)

(72) Inventors: Sinead KELLY, Leixlip (IE); Andua Kwok Kin Hui, Austin, TX (US); Shell S. SIMPSON, Boise, ID (US)

(21) Appl. No.: 15/035,553

(22) PCT Filed: Nov. 20, 2013
(86) PCT No.: PCT/US13/70928

§ 371 Date: May 10, 2016

(51) Int. Cl. H04N 1/00; G06F 3/12

(52) U.S. Cl. CPC H04N 1/00074; H04N 1/00042; G06F 3/121; G06F 3/1204; G06F 3/1287; H04N 2201/0094

(57) ABSTRACT

An event relating to at least one device is received. A type of service for which the at least one device is registered is identified. An action to take in response to the event and the identified type of service is determined, the determining based on application of at least one rule that specifies different actions to take in response to the event for respective different types of services.

### BACKGROUND

Various devices, such as printing devices, can include components that may have to be replenished as a result of use. For example, a printing device can include an ink or toner cartridge that can become depleted over time as a result of use. When depletion of an ink or toner cartridge is detected, a user can order a replacement cartridge online, or alternatively, the user can visit a retail store to purchase a replacement cartridge.

### BRIEF DESCRIPTION OF THE DRAWINGS

Some implementations are described with respect to the following figures.

FIG. 1 is a block diagram of an example arrangement that includes a cloud system for responding to events, in accordance with some implementations.

FIGS. 2 and 3 are flow diagrams of processes for responding to device events, according to various implementations.

FIG. 4 is a block diagram of another example arrangement that includes a cloud system for responding to events, in accordance with further implementations.

FIG. 5 is a block diagram of an example computer system that is capable of incorporating some implementations.

### DETAILED DESCRIPTION

A device can include one or multiple components that may have to be replenished as a result of use. Examples of devices include printing devices, computers, smartphones, game appliances, home appliances, vehicles, or other types of devices. Examples of components of devices include consumable supplies that are consumed during use of the devices. For example, for a printing device, a consumable supply can include an ink or toner cartridge that contains ink or toner used for printing onto print media. Another example of a consumable supply for a printing device is the print media that is loaded into the printing device. A further example of a consumable supply is a battery, whose charge can become depleted due to operation of a device. There are also other examples of consumable supplies. As used herein, a “printing device” may be a hardware device, such as a printer, multifunction printer (MFP), or any other device including at least functionalities for physically producing graphical representation(s) (e.g. text, images, etc.) on paper, or the like. In some examples, an MFP may be capable of performing a combination of multiple different functionalities such as, for example, printing, photocopying, scanning, faxing, etc.

Further examples of components of devices include components that are subjected to wear or that may fail as a result of prolonged use. Examples of such components include disk-based storage devices, flash memory devices, moveable mechanical parts, and so forth.

A component may have to be replenished once depletion, wear, or other specified condition of the component is detected. Replenishing a component of a device can refer to replacing the component, repairing the component, or subjecting the component to maintenance.

Various different types of component replenishment services can be offered to a user or an enterprise. An enterprise can refer to a business concern, an educational organization, a government agency, or any other type of organization. The different types of component replenishment services provide different ways of replenishing a component of a device in response to detecting an event that indicates that component replenishment is to be performed.

For example, in the context of replenishing a supply of a printing device, a first type of a supply replenishment service is a direct purchasing service. With the direct purchasing service, a monitoring system monitors the supply of a printing device. If the monitoring system detects a low level of the supply (e.g. level of supply has dropped below a specified threshold), then the monitoring system provides an alert that the supply is at a low level. In some examples, the alert, which can be in the form of an e-mail message or other type of alert, can include a link selectable by a user to allow the user to navigate to a website from which the user can order replacement supplies.

A different type of supply replenishment service is a contract-based replenishment service, in which a customer (e.g. user or enterprise) enters into an agreement with a service provider to automatically replenish supplies in response to detecting that supplies have reached specified low levels. For example, the contract-based service may be a subscription service, in which a customer pays a periodic fee (e.g. monthly fee, annual fee, etc.) to a service provider, and the service provider monitors the supply of a printing device (or multiple printing devices) of the customer, and automatically replenishes the supply based on the monitoring.

Another type of contract-based replenishment service is a managed print service, in which a service provider can monitor printing devices at a site (or multiple sites) of an enterprise. Upon detection of a low supply level for any of the monitored printing devices, the respective supply can be automatically ordered and delivered to the enterprise.

With a contract-based replenishment service, in some examples, a customer may be presented with one or multiple options associated with ordering a supply. For example, the customer may be given the option of selecting the vendor (from among multiple vendors) from which the supply is to be ordered.

In other examples, a pre-selected vendor model can be used. A customer may provide pre-selected preferences (such as payment and shipping preferences), and can include an identification of a specific vendor, associated with ordering of supplies. The pre-selected preferences can be used when automatically ordering supplies for replenishment.

In the present discussion, reference is made to different types of supply replenishment services for printing devices. However, it is noted that techniques or mechanisms according to some implementations can also be applied to other types of component replenishment services for replenishing components of devices.

A customer may be able to select from multiple different types of supply replenishment services. Accordingly, in response to an event indicating that a supply is to be replenished, an action to take may differ depending upon which of the different types of supply replenishment services the customer is enrolled in. For example, if a customer is participating in a contract-based supply replenishment service, then a detection of a supply low condition should not trigger an alert to the customer to purchase a replacement supply online. Instead, in response to detecting a supply low condition, a replacement supply should be automatically ordered for the customer. In this case, instead of providing a supply low condition alert to the customer, a notification can be sent to the customer that a replacement supply has been automatically ordered.

Conversely, if a customer is participating in a direct purchase supply replenishment service, then an alert should be provided to the customer to allow the customer to order a replacement supply online, in response to detecting a supply low condition.

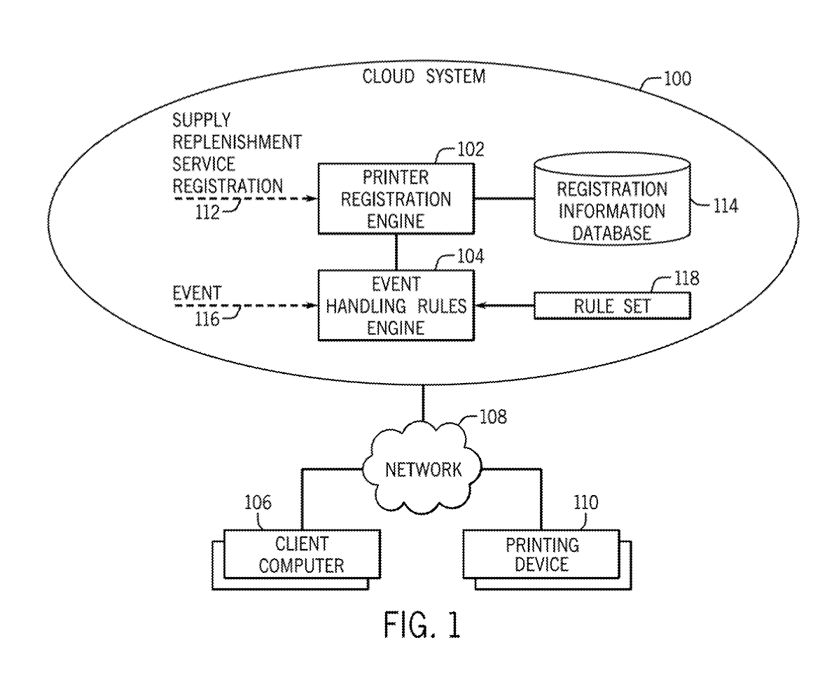

FIG. 1 illustrates an example arrangement that includes a cloud system 100 that includes a printer registration engine 102 and an event handling rules engine 104, in accordance with some implementations. A “cloud system” can refer to a system that is accessible over a network by other devices. The cloud system 100 can be implemented with a computer system or with multiple computer systems, where the multiple computer systems can be geographically distributed in some examples.

Each of the engines of the cloud system 100 may be any combination of hardware and programming to implement the functionalities of the respective engine. Such combinations of hardware and programming may be implemented in a number of different ways. For example, the programming for the engines may be processor executable instructions stored on a non-transitory machine-readable storage medium and the hardware for the engines may include processor(s) to execute those instructions. In such examples, the machine-readable storage medium may store instructions that, when executed by the processor(s), implement the engines of cloud system 100. The machine-readable storage medium storing the instructions may be integrated in a computing device including the processing resource to execute the instructions, or the machine-readable storage medium may be separate but accessible to the computing device and the processing resource. The processing resource may comprise one processor or multiple processors included in a single computing device or distributed across multiple computing devices. In other examples, the functionalities of any of the engines may be implemented in the form of electronic circuitry.

The printer registration engine 102 is accessible by one or multiple client computers 106 over a network 108. Examples of the network 108 include the Internet, a local area network, a wide area network, and so forth. A client computer 106 can access the printer registration engine 102 to register a specific type of supply replenishment service, such as any of the different types of supply replenishment services discussed above, for a printing device (or group of printing devices) 110. The printing device(s) 110 can be owned by an individual user, or alternatively, the printing device(s) 110 can be part of a fleet of printing devices belonging to an enterprise.

In some examples, a client computer 106 can be a user computer that can be used by a user to access the printer registration engine 102 for registering a printing device or group of printing devices 110 with a specific type of supply replenishment service. Alternatively, the client computer 106 can be a server computer that runs machine-readable instructions to automatically select a specific type of supply replenishment service for the printing device(s) 110. As further examples, a client computer 106 can be a printing device 110.

A client computer 106 can include machine-readable instructions, which can include a web-based application or other type of application. The machine-readable instructions at the client computer 106 can access the printer registration engine 102 to perform a supply replenishment service registration procedure (112). As part of the supply replenishment service registration procedure, the printer registration engine 102 can present options relating to different supply replenishment services that are selectable by the client computer 106.

The selected supply replenishment service for the printing device(s) 110 can be stored as part of registration information for the printing device(s) 110 in a registration information database 114. The registration information can identify the printing device(s) 110, and can also store information indicating the registered type of supply replenishment service for the printing device(s) 110.

The registration information database 114 can include multiple entries for respective different groups of printing devices. Each entry of the registration information database 114 includes information indicating the registered type of supply replenishment service for the respective group of one or multiple printing devices.

More generally, the printer registration engine 102 can be substituted with a component registration service, which allows a client computer 106 to select one of multiple different types of component replenishment services for a respective group of one or multiple devices.

The event handling rules engine 104 can receive an event (116) that relates to the printing device(s) 110 (or more generally, to one or multiple devices). The event 116 can be triggered in response to detection of a low supply condition (e.g. an ink or toner low condition of an ink or toner cartridge of a printing device 110). The detection of the supply low condition can be performed by a monitoring system (not shown) in each printing device 110, or external of the printing device(s) 110.

In response to the event 116, the event handling rules engine 104 accesses a rule set 118 (which includes one or multiple rules) to determine an action to take in response to the event 116. The event handling rules engine 104 also accesses the registration information database 114 to determine (or identify) the type of supply replenishment service for which the printing device 110 that triggered the event 116 is registered. The rule set 118 specifies different actions to take in response to the event 116 for respective different types of supply replenishment services.

If a contract-based supply replenishment service is registered for the printing device(s) 110, then the rule set 118 can specify that the action to take in response to the event 116 is to automatically order a replacement supply, without sending an alert to the customer to invite the customer to order the replacement supply online. Instead, a notification (e.g. web page, e-mail, etc.) can be sent to the customer indicating that a replacement supply has been automatically ordered, and the notification can include further information relating to the ordered replacement supply. On the other hand, if the supply replenishment service registered for the printing device(s) 110 is a direct purchase service, then the rule set 118 can specify that an alert should be sent to a customer regarding the supply low condition, where the alert can include a link that is selectable by the customer to navigate the customer to a website for ordering a replacement supply.

The rule set 118 that is used by the event handling rules engine 104 can be configurable, such as by a portal (not shown). The portal allows an administrator or other user to access the event handling rules engine 104 to modify the rule set 118.

In the foregoing example, the event 116 is assumed to be an event relating to a supply low condition. In other examples, the event 116 can be a different event. As examples, such different events can include an event relating to a life expectancy of a component (e.g. the component is nearing end of life), an event relating to installation of a component, an event relating to removal of a component, an event relating to wear of a component, an event relating to a fault or failure of a component, an event indicating a brand of an installed component (e.g. whether an installed ink or toner cartridge is a genuine cartridge from a specific vendor), and so forth.

In addition to specifying actions to relating to supply replenishment (e.g. providing an alert including a link to a website for ordering a replacement supply, automatically ordering a replacement supply, or providing a notification that a replacement supply has been automatically ordered), the rule set 118 can also specify other types of action.

For example, an action that can be specified by the rule set 118 can relate to a customer loyalty program. If an event indicates that a replacement supply from a specific vendor was ordered, then the rule set 118 can specify that a customer's account is to be updated to reflect the purchase of the replacement supply (e.g. increase award points, provide discounts towards purchase of future goods or services, and so forth).

As another example, the customer's account is updated in the background when a replacement supply from a specific vendor was ordered, without involving the event handling rules engine 104. However, in this case, the rule set 118 can specify that an event indicating that a replacement supply from a specific vendor was ordered can trigger a different action, such as sending updated information regarding the loyalty program to the customer.

As other examples, the rule set 118 can specify that a marketing message can be provided to a customer in response to an event. The marketing message can include information advertising a good or service, or may offer an incentive (e.g. discount) to a customer for purchasing a good or service. The marketing message may be customized based on various criteria, including a location of a customer, the usage of a printing device by the customer, a profile of the customer (e.g. age, occupation, etc.), and other criteria. The marketing message may also encourage a customer to switch from one type of supply replenishment service (e.g. direct purchasing service) to a different type of supply replenishment service (e.g. contract-based service).

The printer registration engine 102 can be accessed to determine whether a printing device is already registered for a specific supply replenishment service. If the printer registration engine 102 indicates (based on the registration information database 114) that the printing device is already registered for a specific supply replenishment service, then a client computer 106 may suppress an advertisement of availability of other types of supply replenishment services. Alternatively, the client computer 106 may indicate that the printing device is already registered for a specific supply replenishment service, and may also present an option to a customer to change to a different supply replenishment service.

In some implementations, the printer registration engine 102 can also provide contention management. Generally, a printing device should be registered for just one type of supply replenishment service. If a client computer 106 attempts to register the same printing device with another type of supply replenishment service, then the printer registration engine 102 may handle the subsequent registration request in one of several manners. In a first manner, the printer registration engine 102 may simply notify the client computer 106 that the subsequent registration request conflicts with an earlier registration of the printing device. Alternatively, the printer registration engine 102 may reject the subsequent registration request, but may provide un-registration instructions for the currently registered supply replenishment service, to allow a customer to un-register the previous supply replenishment service, such that a different supply replenishment service can be registered for the printing device.

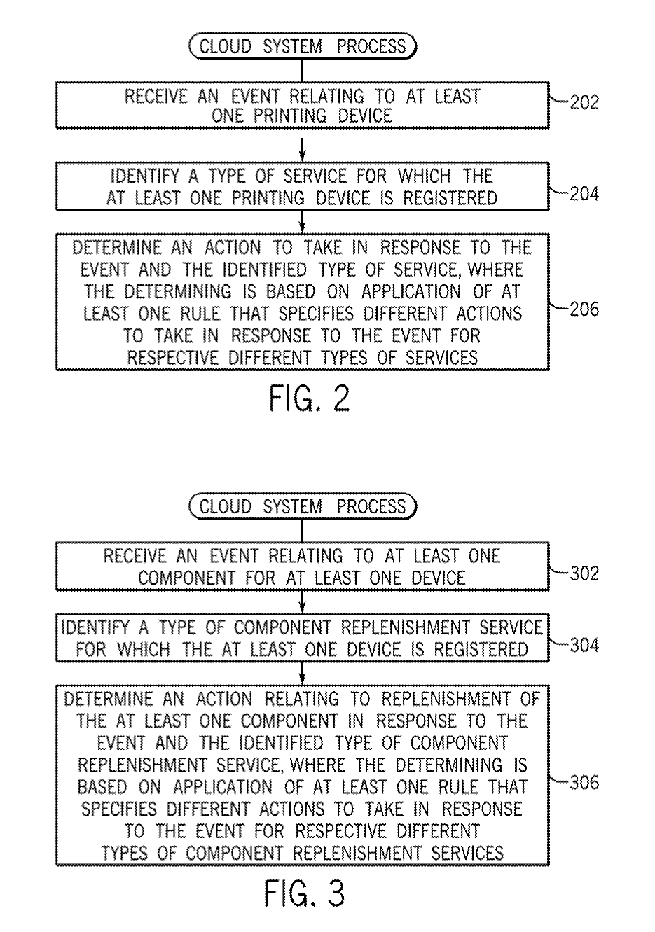

FIG. 2 is a flow diagram of a process that can be performed by the cloud system 100 according to some implementations. The cloud system 100 receives (at 202) an event (e.g. event 116 of FIG. 1) relating to at least one printing device (e.g. printing device 110). The cloud system 100 identifies (at 204) a type of service for which the at least one printing device is registered, such as by accessing the registration information database 114 of FIG. 1.

The cloud system 100 determines (at 206) an action to take in response to the event and the identified type of service, where the determining is based on application of at least one rule (in the rule set 118 of FIG. 1) that specifies different actions to take in response to the event for respective different types of services.

FIG. 3 is a flow diagram of a process that can be performed by the cloud system 100, according to alternative implementations. The cloud system 100 receives (at 302) an event relating to at least one component for at least one device. The cloud system 100 identifies (at 304) a type of component replenishment service for which the at least one device is registered.

The cloud system 100 determines (at 306) an action relating to replenishment of the at least one component in response to the event and the identified type of component replenishment service, where the determining is based on application of at least one rule that specifies different actions to take in response to the event for respective different types of component replenishment services.

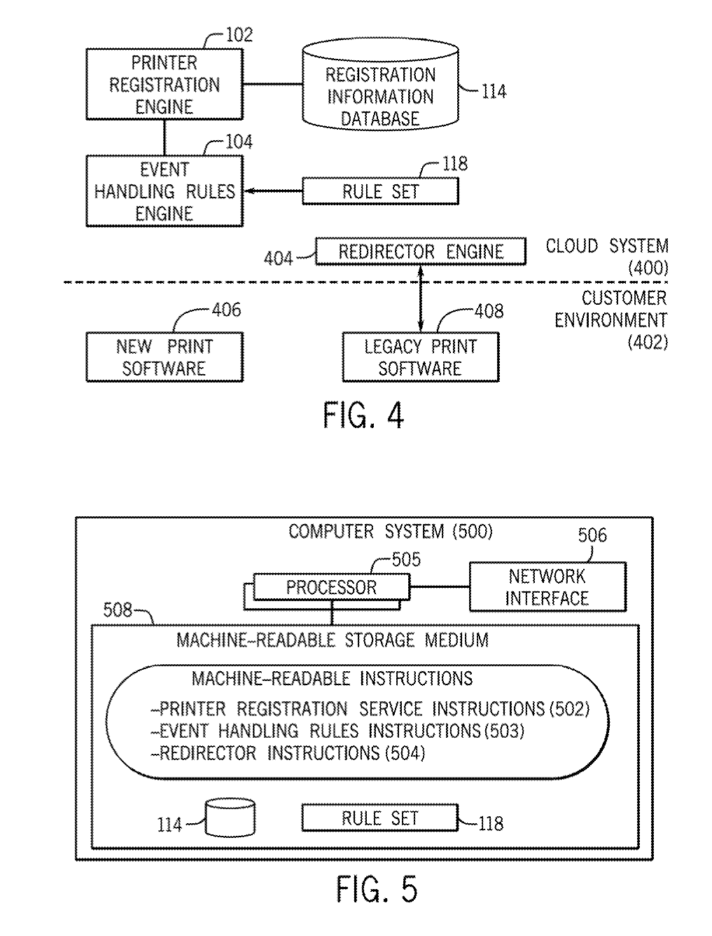

FIG. 4 is a schematic diagram of an example arrangement according to further implementations. The example arrangement includes a cloud system 400, which is similar to the cloud system 100 of FIG. 1, except that the cloud system 400 further includes a redirector engine 404, which may include electronic circuitry or any combination of hardware and programming, as described above, to implement the functionalities described herein in relation to engine 404.

FIG. 4 also shows print software 406 and 408 that can be deployed in a customer environment 402, such as on a client computer 106 and/or printing device 110. The print software 406 and 408 can include machine-readable instructions. Although reference is made to “print software,” it is noted that the machine-readable instructions can also be implemented as firmware.

The print software includes a new print software 406 and legacy print software 408. The “new” print software 406 refers to software (which can be deployed in a client computer 106 and/or printing device 110) that is able to interact with the print registration engine 102 and event handling rules engine 104 of the cloud system 400. For example, the new print software 406 is able to interact with the printer registration engine 102 to determine what supply replenishment services to advertise for selection. As another example, the new print software 406 is able to interact with the event handling rules engine 104 to determine an action to take in response to an event.

The “legacy” print software 408 refers to software that is not designed to interact with either or both of the printer registration engine 102 or event handling rules engine 104. For example, the legacy print software 408 is able to generate an alert in response to a supply low condition of a printing device, where the alert can include a link to a website for online ordering of a replacement supply. The legacy print software 408 assumes that a direct purchase service is registered for the printing device. However, if the printing device is actually registered for a different type of supply replenishment service, the legacy print software 408 is unable to interact directly with the event handling rules engine 104 to identify a different action to take.

In accordance with some implementations, the redirector engine 404 in the cloud system can provide a bridge between the legacy print software 408 and the event handling rules engine 104. The redirector engine 404 may also provide a bridge between the legacy print software 408 and the printer registration engine 102.

The redirector engine 404 may receive an alert from the legacy print software 408 regarding a supply low condition of a printing device. For example, the alert may be triggered when a user clicks on a link included in a message indicating a supply low condition. The link can include a uniform resource locator (URL) that corresponds to the redirector engine 404. The alert can be a message produced by the clicking of the link, where the message is submitted to the redirector engine. In response, the redirector engine 404 can interact with the event handling rules engine 104 to determine the appropriate action to take in response to the event, based on which type of supply replenishment service is registered for the printing device.

FIG. 5 is a block diagram of an example computer system 500 according to some implementations, which can represent one computer or a distributed arrangement of computers. The computer system 500 includes a machine-readable storage medium 508 that stores various machine-readable instructions, including printer registration instructions 502, event handling rules instructions 503, and redirector instructions 504 to implement, when executed, the functionalities described above in relation to the printer registration engine 102, event handling rules engine 104, and redirector engine 404, respectively.

The machine-readable instructions 502-504 are executable on one or multiple processors 505, which can be coupled to a network interface 506 and the machine-readable storage medium 508. A processor can include a microprocessor, microcontroller, processor module or subsystem, programmable integrated circuit, programmable gate array, or another control or computing device. The network interface 506 allows the computer system 500 to communicate over a network, such as the network 108. The storage medium (or storage media) 508 can store various information, such as the registration information database 114 and the rule set 118.

As used herein, a “machine-readable storage medium” may be any electronic, magnetic, optical, or other physical storage apparatus to contain or store information such as executable instructions, data, and the like. For example, any machine-readable storage medium described herein may include any of various different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution. Further, any machine-readable storage medium described herein may be non-transitory.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
receiving, by a system including a processor, an event relating to at least one printing device;
identifying, by the system, a type of service for which the at least one printing device is registered; and
determining, by the system, an action to take in response to the event and the identified type of service, the determining based on application of at least one rule that specifies different actions to take in response to the event for respective different types of services.

2. The method of claim 1, wherein the different types of services include different types of component replenishment services for replenishing at least one component of the at least one printing device.

3. The method of claim 1, wherein receiving the event comprises receiving an event relating to a level or life expectancy of a supply of the at least one printing device.

4. The method of claim 1, wherein receiving the event comprises receiving an event relating to a component of the at least one printing device.

5. The method of claim 4, wherein the event relating to the component of the at least one printing device comprises an event selected from among installation of the component, removal of the component, and a brand of the component.

6. The method of claim 1, wherein the determined action comprises updating an account relating to a customer loyalty program.

7. The method of claim 1, wherein the determined action comprises sending a marketing message relating to a good or service.

8. The method of claim 1, wherein receiving the event and determining the action to take are performed by a rules engine that is part of a cloud system.

9. The method of claim 8, wherein the cloud system further includes a registration engine, the method further comprising:
responsive to a registration procedure initiated by a client computer, selecting, by the registration engine, one of the different types of services to register for the printing device.

10. A system comprising:
an event handling rules engine to receive an event relating to at least one component for at least one device;
the event handling rules engine further to identify a type of component replenishment service for which the at least one device is registered; and
the event handling rules engine further to determine an action relating to replenishment of the at least one component in response to the event and the identified type of component replenishment service, the determining based on application of at least one rule that specifies different actions to take in response to the event for respective different types of component replenishment services.

11. The system of claim 10, further comprising:
a printer registration engine to perform a registration procedure to register the at least one device for a selected one of the different types of component replenishment services.

12. The system of claim 11, further comprising a registration database to store information indicating respective component replenishment services registered for different groups of devices.

13. The system of claim 11, wherein the printer registration engine is further to:
detect that a further registration procedure attempts to register the at least one device for a different type of component replenishment service; and
perform contention management to avoid registering the at least one device for multiple component replenishment services.

14. The system of claim 10, further comprising:
a redirector engine to provide a bridge between legacy machine-readable instructions and the rules engine, the legacy machine-readable instructions incapable of interacting directly with the rules engine.

15. An article comprising at least one non-transitory machine-readable storage medium storing instructions that upon execution cause a cloud system to:
receive an event relating to at least one printing device;
identify a type of supply replenishment service for which the at least one printing device is registered; and
determine an action to take in response to the event and the identified type of supply replenishment service, the determining based on application of at least one rule that specifies different actions to take in response to the event for respective different types of supply replenishment services.
